(19) United States
(12) Patent Application Publication
(10) Pub. No.: US 2011/0087869 A1
(43) Pub. Date: Apr. 14, 2011

(54) IMAGE FORMING APPARATUS, IMAGE FORMING SYSTEM, AND METHOD OF CONFIGURING IMAGE FORMING APPARATUS

(75) Inventor: Masahide Teranoshita, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/872,115

(22) Filed: Aug. 31, 2010

Related U.S. Application Data
(60) Provisional application No. 61/249,764, filed on Oct. 8, 2009.

(51) Int. Cl. G06F 9/00

(52) U.S. Cl. 713/1

(57) ABSTRACT

According to one embodiment, there is provided an image forming apparatus including a configuration creating unit, a storage, a timer, a schedule management unit, and a configuration processing unit. The configuration creating unit creates machine configuration information in accordance with the contents of a machine configuration input by a user. The storage stores the machine configuration information created by the configuration creating unit. The timer measures the present date and time. The schedule management unit retrieves machine configuration information that is to be applied to the image forming apparatus based on the present date and time measured by the timer and the schedule of the machine configuration information stored in the storage. The configuration processing unit applies machine configuration information retrieved by the schedule management unit as the machine configuration information to be applied to the image forming apparatus.

### CROSS-REFERENCE TO RELATED APPLICATION

This application is based upon and claims the benefit of priority from U.S. Provisional Application No. 61/249,764 filed on Oct. 8, 2009; the entire contents of which are incorporated herein by reference.

### FIELD

Embodiments described herein relate generally to an image forming apparatus, an image forming system, and method of configuring an image forming apparatus.

### BACKGROUND

Conventionally, the machine configurations of an image forming apparatus such as a digital multi-function peripherals can be changed by an operation of an administrator. A user who wants to change the machine configurations of the digital multi-function peripherals sends a machine configuration change request to the administrator. Whenever receiving the machine configuration change request from the user, the administrator operates an operation panel of the digital multi-function peripherals to change the machine configurations. The user needs to find the administrator having the right to approve the changes and let the administrator know the changes to the machine configurations. The administrator has to spend time and effort changing the machine configurations. Therefore, in an image forming apparatus such as a digital multi-function peripherals, it is desirable to make it easy to change the machine configurations based on an approval by an authorized administrator.

### BRIEF DESCRIPTION OF THE DRAWINGS

FIG. 1 is a diagram schematically showing a configuration example of an image forming system.

FIG. 2 is a block diagram showing a configuration example of a control system of a digital multi-function peripherals and a server.

FIG. 3 is a diagram showing a configuration example of a machine configuration unit.

FIG. 4 is a diagram showing a configuration example of an approval candidate list.

FIG. 5 is a flowchart illustrating the flow of an approval candidate list registration process.

FIG. 6 is a diagram showing a configuration example of a configuration information list.

FIG. 7 is a flowchart illustrating the flow of a machine configuration information reception process.

FIG. 8 is a display example of an approval processing screen.

FIG. 9 is a diagram showing a configuration example of an approval processing information list.

FIG. 10 is a flowchart illustrating the flow of a machine configuration information approval process.

FIG. 11 is a flowchart illustrating the flow of a process of managing the schedule of machine configuration information.

FIG. 12 is a flowchart illustrating the flow of a machine configuration information management process in the machine configuration unit.

### DETAILED DESCRIPTION

In general, according to one embodiment, there is provided an image forming apparatus including a configuration creating unit, a storage, a timer, a schedule management unit, and a configuration processing unit. The configuration creating unit creates machine configuration information in accordance with the contents of a machine configuration input by a user. The storage stores the machine configuration information created by the configuration creating unit. The timer measures the present date and time. The schedule management unit retrieves machine configuration information that is to be applied to the image forming apparatus based on the present date and time measured by the timer and the schedule of the machine configuration information stored in the storage. The configuration processing unit applies machine configuration information retrieved by the schedule management unit as the machine configuration information to be applied to the image forming apparatus.

An embodiment of the invention will be described in detail with reference to the accompanying drawings.

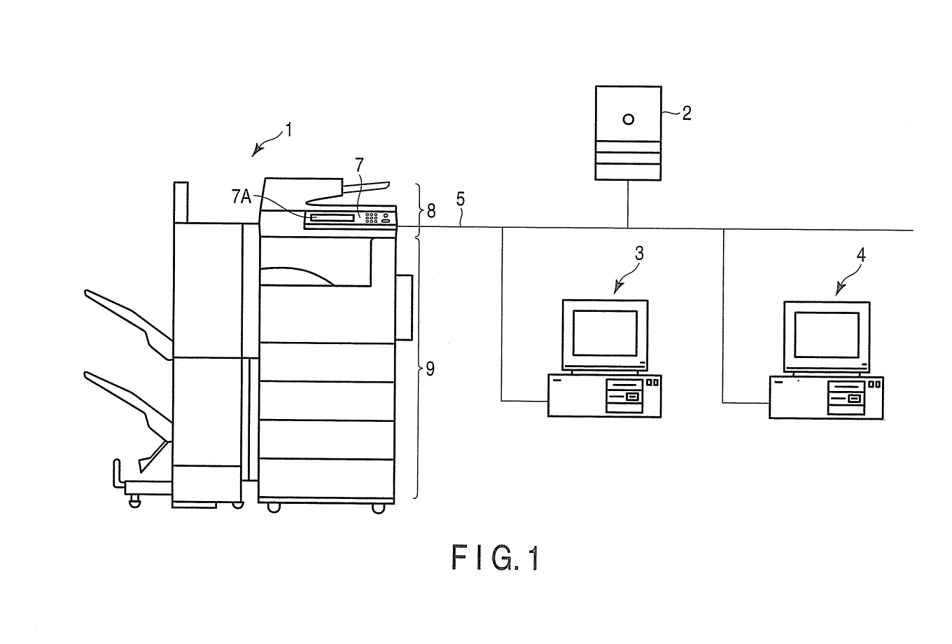

FIG. 1 is a diagram schematically showing a configuration example of an image forming system.

As shown in FIG. 1, the image forming system includes a digital multi-function peripherals 1, a server 2, a user terminal 3, and an administrator terminal 4. In the image forming system, the digital multi-function peripherals 1, the server 2, the user terminal 3, and the administrator terminal 4 are connected through a local area network 5.

The digital multi-function peripherals (MFP) 1 functions as an image forming apparatus (printing apparatus). The digital multi-function peripherals 1 includes a scanner function, a printer function, a network communication function, and the like. The digital multi-function peripherals 1 has a function of performing data communication with each device (the server 2, user terminal 3, and administrator terminal 4) through the local area network 5. For example, the digital multi-function peripherals 1 functions as a network printer that executes a print job requested from the user terminal 3.

The server 2 is a server computer. The server 2 has a function of performing data communication with each device through the local area network 5. The user terminal 3 is a terminal device used by a user. The user terminal 3 has a function of performing data communication with each device through the local area network 5. The user terminal 3 is a personal computer, for example. Moreover, the user terminal 3 may be a mobile terminal device capable of communicating with the digital multi-function peripherals 1.

The administrator terminal 4 is a terminal device used by an administrator. The administrator terminal 4 has a function of performing data communication with each device through the local area network 5. The administrator terminal 4 may be any device as long as it is capable of communicating with the digital multi-function peripherals 1. The administrator terminal 4 is configured by a personal computer and the like, for example. Moreover, the administrator terminal 4 may be a mobile terminal device capable of communicating with the digital multi-function peripherals 1. The local area network 5 may be realized by wireless communication or the like.

Next, the schematic configuration of the digital multi-function peripherals 1 will be described.

As shown in FIG. 1, the digital multi-function peripherals 1 includes an operation panel 7, a scanner (image reading unit) 8, a printer (image forming unit) 9, and the like. Moreover, the digital multi-function peripherals 1 includes various external interfaces to and from which image data are input and output. The digital multi-function peripherals 1 functions as a copier, a scanner, a printer, or a network communicator.

The scanner 8 reads images on the surface of an original document to acquire color or monochrome image data. The scanner 8 reads the images on the surface of the original document by optically scanning the surface of the original document. The scanner 8 includes a scanning mechanism, a photoelectric conversion unit, a document feeding device (ADF), and the like.

The printer 9 forms color or monochrome images on a paper. For example, the printer 9 is an electrophotographic-type image forming apparatus. The printer 9 includes a paper accommodation unit, a transport mechanism, an exposure device, a photoconductive drum, a developing device, a transfer belt, a transfer device, a fixing device, and the like. In the printer 9, the transport mechanism transports paper set in the paper accommodation unit. The exposure device forms latent images on the photoconductive drum. The developing device develops the latent images on the photoconductive drum with toner (or toner of each color in the case of printing a color image). The transfer device transfers toner images on the photoconductive drum developed by the developing device on a paper via the transfer belt. The fixing device fixes the toner images on the paper by heating the paper in a pressed state, for example. The transport mechanism discharges the sheet having the toner images fixed thereto as a printing result. The printer 9 is not limited to an electrophotographic type and may perform image formation by a printing method such as an ink jet method or a heat-transfer type.

The operation panel 7 is a user interface. For example, the operation panel 7 includes various operation keys, a touch panel-attached display device 7a, and the like. The operation panel 7 functions as an operation unit for allowing a user to input an operation instruction and a display unit for displaying guidance information to the user. For example, the user uses the operation panel 7 to input a machine configuration change request.

Next, the configuration of a control system of the multi-function printer 1 will be described.

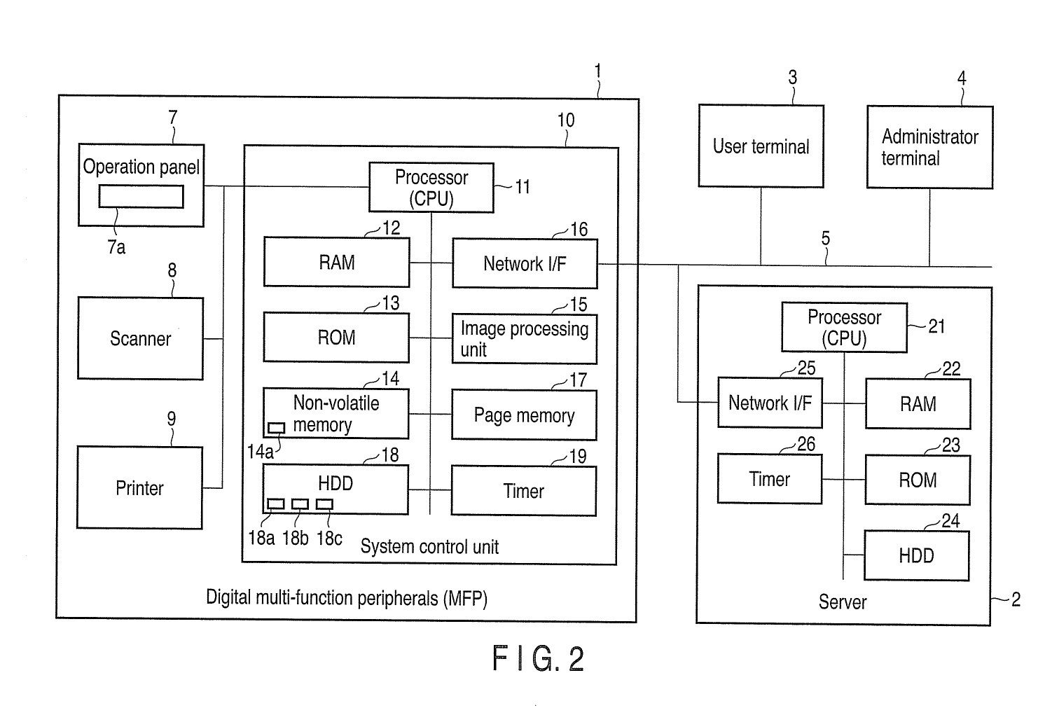

FIG. 2 is a block diagram showing a configuration example of a control system of the digital multi-function peripherals 1.

As shown in FIG. 2, the digital multi-function peripherals 1 includes a system control unit 10 that controls an overall operation of each and every unit. For example, the system control unit 10 controls the scanner 8 and the printer 9. The system control unit 10 acquires information input by the user or the administrator from the operation panel 7, the user terminal 3 or the administrator terminal 4. The system control unit 10 includes a processor (CPU) 11, a random-access memory (RAM) 12, a read-only memory (ROM) 13, a non-volatile memory 14, an image processing unit 15, an network interface 16, a page memory 17, a hard disk drive (HDD) 18, a timer 19, and the like.

The processor 11 is a CPU, for example. The processor 11 executes various processing functions by executing a control program stored in the ROM 13, the non-volatile memory 14, or the HDD 18. The RAM 12 is a main memory functioning as a working memory. The ROM 13 stores a control program, control data, and the like necessary for controlling the operation of the digital multi-function peripherals 1. The non-volatile memory 14 is a rewritable non-volatile memory. The non-volatile memory 14 stores a control program, control data, and the like necessary for executing various processing functions.

The non-volatile memory 14 includes a storage area 14a for storing information (machine configuration information) that represents the present machine configurations of the digital multi-function peripherals 1. The machine configurations are configurations related to the basic operation of the digital multi-function peripherals 1. The machine configurations are different from processing settings of a job (copy, scan, print, or the like). For example, the machine configurations are configuration related to management of the digital multi-function peripherals 1 such as security configurations or operation restrictions. In other words, the digital multi-function peripherals 1 can be operated in accordance with basic configuration information stored in the storage area 14a of the non-volatile memory 14.

The image processing unit 15 processes image data read by the scanner 8 or image data received via a network. The network interface 16 is an interface for performing communication with an external device through the local area network 5. The page memory 17 is a memory that has a storage area in which image data of at least one page are expanded. The HDD 18 is a large-volume memory for data storage. The HDD 18 stores image data to be printed, for example. The HDD 18 has an approval candidate list 18a, a machine configuration information list 18b, and an approval processing information list 18c. The approval candidate list 18a, the machine configuration information list 18b, and the approval processing information list 18c may be stored in the non-volatile memory 14. The timer 19 measures the present time. Moreover, the timer 19 may measure an elapsed time.

Next, the configuration of the server 2 will be described.

FIG. 2 is a block diagram showing a configuration example of a control system of the server 2.

The server 2 has the communication function of the digital multi-function peripherals 1. The server 2 can perform the configuration function of the digital multi-function peripherals 1. Moreover, the server 2 is also capable of performing a function of changing and managing the configurations of a plurality of digital multi-function peripherals.

In the configuration example shown in FIG. 2, the server 2 includes a processor (CPU) 21, a RAM 22, a ROM 23, an HDD 24, a network interface (I/F) 25, and a timer 26.

The processor 21 is a CPU, for example. The processor 21 controls an overall operation of the server 2. The processor 21 executes various processing functions by executing a control program stored in the ROM 23 or the HDD 24. The RAM 22 is a working memory. The ROM 23 stores a control program, control data, and the like necessary for controlling the basic operation of the server 2. The HDD 24 is a data storage device. The network interface 25 is an interface for performing data communication with each device in the local area network 5. The timer 26 measures the present time. Moreover, the timer 26 may measure an elapsed time.

Next, the machine configurations of a digital multi-function peripherals will be described.

In the present embodiment, the machine configurations are basic operation configurations of a digital multi-function peripherals. The machine configurations are different from processing settings such as copy settings, scan settings, or print settings which the user sets for each job such as copy, scan, or print. The machine configurations applied to the digital multi-function peripherals need to be approved by an administrator having the right to manage the digital multi-function peripherals. Therefore, when the machine configurations are changed, a procedure where an administrator approves the changes to the machine configurations is required.

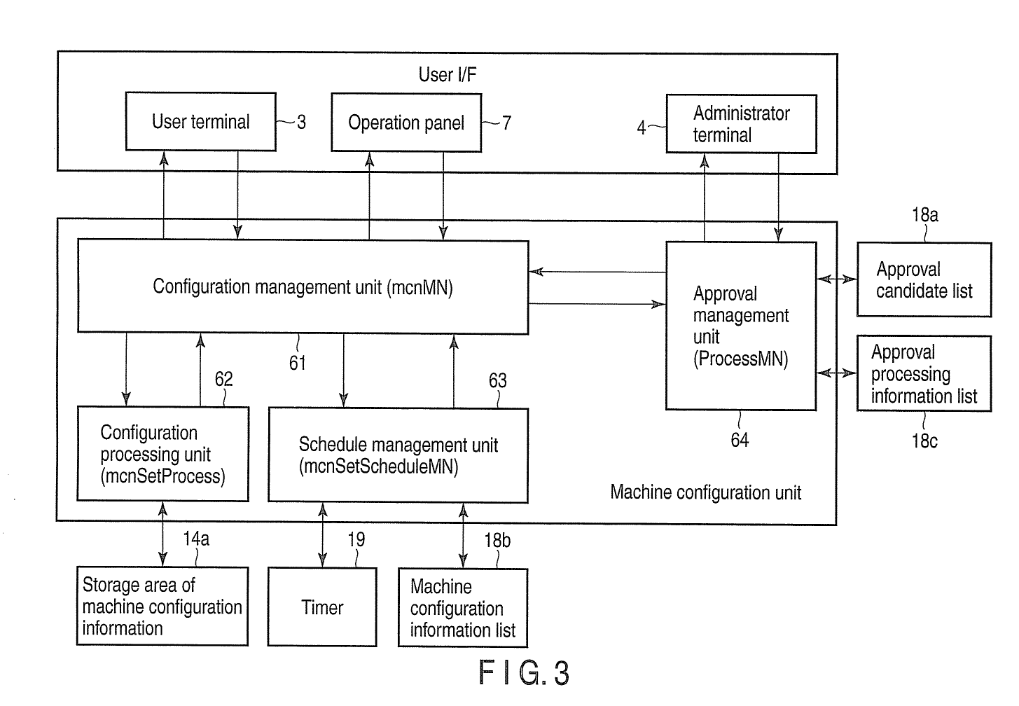

FIG. 3 is a diagram showing a configuration example of a machine configuration function (machine configuration unit) for applying machine configurations to a digital multi-function peripherals.

As shown in FIG. 3, a machine configuration unit 60 includes a configuration management unit (mcnMN) 61, a configuration processing unit (mcnSetProcess) 62, a schedule management unit (mcnSetScheduleMN) 63, and an approval management unit (ProcessMN) 64. In the present embodiment, the processor 11 in the system control unit 10 of the digital multi-function peripherals 1 executes the machine configuration unit 60 serving as the machine configuration function by executing a program. In this case, a part or an entirety of the machine configuration unit 60 may be realized by the server 2 which is capable of communicating with the digital multi-function peripherals 1.

The configuration management unit 61 is a machine configuration management function that manages overall machine configurations of the digital multi-function peripherals 1. The configuration management unit 61 controls processing procedures of other functions. The configuration management unit 61 receives a machine configuration change request from a user through a user interface (I/F). For example, the configuration management unit 61 receives a machine configuration change request from a user through a user I/F such as the user terminal 3, the operation panel 7 or the administrator terminal 4. The configuration management unit 61 also has a function of notifying the user of information.

The configuration management unit 61 creates machine configuration information representing the contents of a machine configuration change request sent from a user. The configuration management unit 61 requests the schedule management unit 63 to manage the schedule of the created machine configuration information. The configuration management unit 61 requests the approval management unit 64 to approve the created machine configuration information. The configuration management unit 61 causes an approval result from the approval management unit 64 to be reflected on the machine configuration information managed by the schedule management unit 63. The configuration management unit 61 notifies the configuration processing unit 62 of machine configuration information for which a configuration request is sent from the schedule management unit 63.

The configuration processing unit 62 is a machine configuration processing function that applies a machine configuration to the digital multi-function peripherals 1. The configuration processing unit 62 applies a machine configuration to the digital multi-function peripherals 1 based on the machine configuration information instructed by the configuration management unit 61. The configuration processing unit 62 stores the machine configuration information in the storage area 14a. The configuration processing unit 62 applies a machine configuration to the digital multi-function peripherals 1 based on the machine configuration information stored in the machine configuration information storage area 14a.

The schedule management unit 63 is a schedule management function that manages the schedule of the machine configuration information. The schedule management unit 63 registers the machine configuration information created by the configuration management unit 61 in the machine configuration information list 18b. The schedule management unit 63 manages the approval result for the machine configuration information registered in the machine configuration information list 18b. The schedule management unit 63 retrieves machine configuration information to be applied to the digital multi-function peripherals based on the schedule of each machine configuration information registered in the machine configuration information list 18b and the present date and time measured by the timer 19. If a state where the approval result for machine configuration information is not obtained continues for a predetermined period or longer, the schedule management unit 63 may notify a user (requester) who sent a machine configuration change request for the machine configuration information of the fact that approval processing for the requested machine configuration has not been completed.

The approval management unit 64 is an approval process management function that manages the process of approving machine configuration information. The approval management unit 64 has a function of creating the approval candidate list 18a which shows an administrator (approval candidate) having the right to approve machine configuration information. The approval management unit 64 executes processing for obtaining an approval of the machine configuration information requested from the configuration management unit 61. The approval management unit 64 receives a machine configuration information approval request from the configuration management unit 61. The approval management unit 64 specifies an approval candidate for the machine configuration information for which the approval request was received with reference to the approval candidate list 18a. A plurality of persons may be specified as approval candidates for one machine configuration information.

The approval management unit 64 notifies all approval candidates of the request for approval of the machine configuration information. The approval management unit 64 creates approval processing information representing the status of an approval procedure by each approval candidate. The approval management unit 64 stores the approval processing information in the approval processing information list 18c. Whenever receiving the approval result from the approval candidate, the approval management unit 64 updates the approval processing information in the approval processing information list 18c. The approval management unit 64 notifies the configuration management unit 61 of the approval processing information (a final approval result for machine configuration information) for which the approval results from all approval candidates are obtained.

Next, setting (registration or update) an approval candidate for machine configuration information will be described.

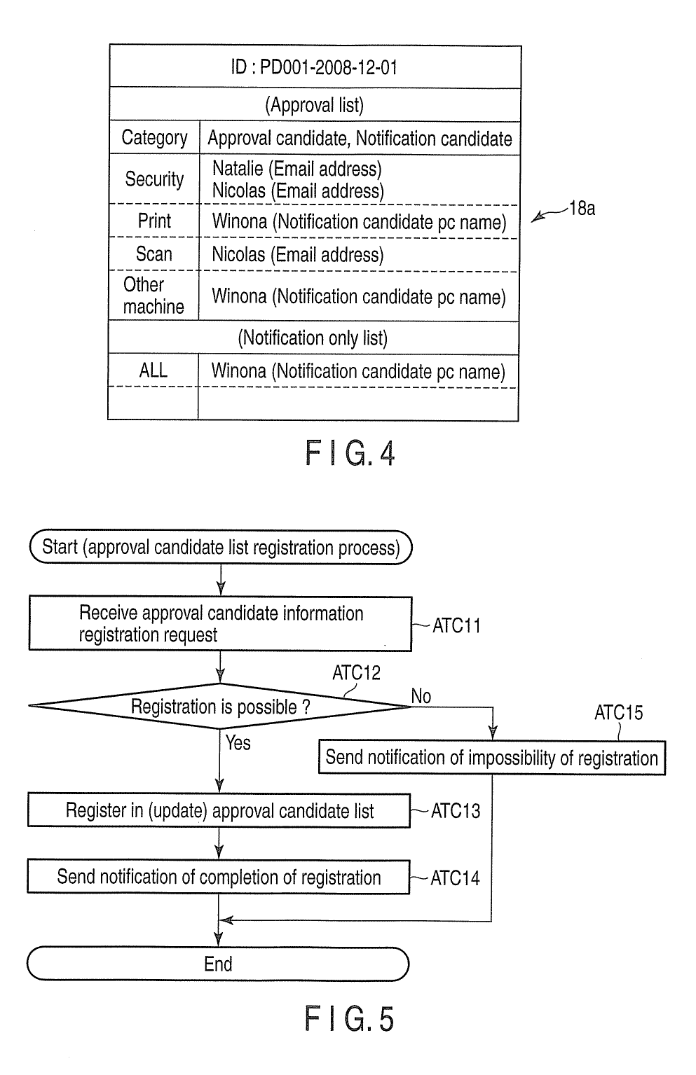

FIG. 4 is a diagram showing an example of the approval candidate list 18a.

The approval candidate list 18a includes information (approval list) representing the approval candidate for each setting item (category) and the contact information thereof. In the example shown in FIG. 4, the approval candidate list 18a has information representing an approval candidate and contact information thereof (e-mail address or terminal information of the approval candidate) for each category, for example, such as security settings, print settings, scan settings, and other machine settings. The approval candidate list 18a may set a plurality of approval candidates for one category. In the approval candidate list 18a shown in FIG. 4, a notification list is also stored together with the approval list representing the approval candidate and the contact information thereof. The notification list is information representing an administrator to be notified of the approval result for machine configuration information and the contact information of the administrator, for example.

The approval management unit 64 may be able to register the information input by the administrator using the administrator terminal 4 in the approval candidate list 18a. For example, the approval management unit 64 receives information (an approval candidate list or a notification candidate list) input by an administrator using the administrator terminal 4 or the like, the administrator having been confirmed to have the right to register information in the approval candidate list 18a. Upon receiving the approval list or the notification list input by the administrator, the approval management unit 64 registers information representing an approval candidate or information representing a notification address of the approval result or the like in the approval candidate list 18a.

Next, the flow of a registration process of the approval candidate list 18a will be described.

FIG. 5 is a flowchart illustrating the flow of an example of a process of registering (updating) the approval candidate list 18a.

The digital multi-function peripherals 1 receives a request for registering (updating) approval candidate information or notification candidate information in the approval candidate list 18a. For example, the administrator inputs information to be registered in the approval candidate list 18a using the administrator terminal 4. The system control unit 10 receives a request for registration of the information input by the administrator terminal 4 through the network interface 16. Moreover, the information to be registered in the approval candidate list 18a may be input using the operation panel 7.

When a request for registration of information in the approval candidate list 18a is received (ACT 11), the processor 11 of the system control unit 10 determines whether or not registration of the information in the approval candidate list 18a by the approval management unit 64 is possible (ACT 12). For example, the approval management unit 64 determines whether or not the registration in the approval candidate list 18a is possible by verifying whether a person who has requested to register information on an approval candidate or a notification candidate is an administrator having the right to register information in the approval candidate list 18a.

When it is determined that the registration of information to the approval candidate list 18a is possible (ACT 12: YES), the approval management unit 64 registers the information requested for registration in the approval candidate list 18a (ACT 13). When the registration of information in the approval candidate list 18a is completed, the approval management unit 64 notifies the administrator (the administrator terminal) who has requested for the registration of the fact that the registration has been completed (ACT 14). Moreover, when it is determined that the registration of information to the approval candidate list 18a is not possible (ACT 12: NO), the approval management unit 64 notifies the administrator (the administrator terminal) who has requested for the registration of the fact that the registration is not possible (ACT 15).

According to the process of registering information in the approval candidate list 18a, the administrator having the right to register information in the approval candidate list 18a can register the information input by the administrator terminal 4 or the operation panel 7 in the approval candidate list 18a. Moreover, the approval candidate list 18a can register an approval candidate and the contact information thereof for each configuration item (category).

Next, a process of receiving the machine configuration information will be described.

The digital multi-function peripherals receives changes to the machine configurations from the user. The user inputs the contents of machine configurations using the user terminal 3 or the operation panel 7. The system control unit 10 of the digital multi-function peripherals 1 receives a machine configuration change request including the contents of a machine configuration from the user terminal 3 or the operation panel 7. For example, the system control unit 10 of the digital multi-function peripherals 1 receives a machine configuration change request input by the user terminal 3 through the network interface 16.

The processor 11 of the system control unit 10 registers the contents of the machine configuration received from the user using the machine configuration unit 60 and requests for approval of the machine configuration information to an approval candidate. In the machine configuration unit 60, the configuration management unit 61 creates the machine configuration information in accordance with the contents of the machine configuration requested by the user. The configuration management unit 61 requests the schedule management unit 63 to register the created machine configuration information in the machine configuration information list 18b. Moreover, the configuration management unit 61 requests the approval management unit 64 to perform the approval procedure for the created machine configuration information.

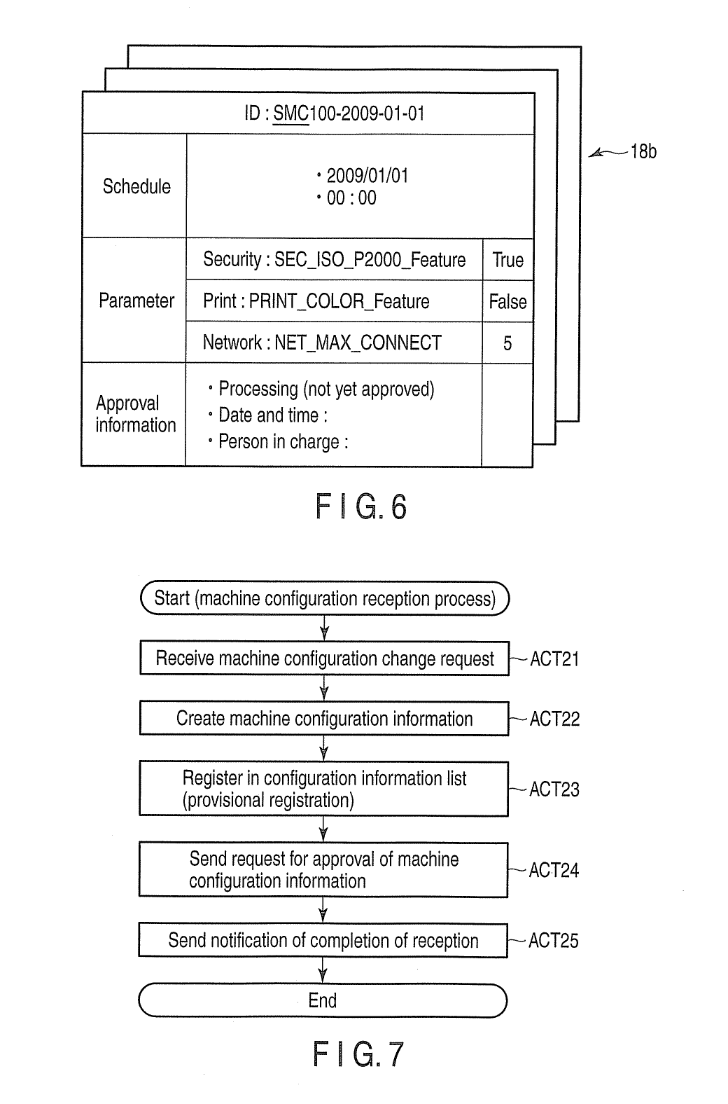

FIG. 6 is a diagram showing an example of the machine configuration information list 18b.

The machine configuration information list 18b is a list of machine configuration information. In the example shown in FIG. 6, the machine configuration information includes schedule, parameters, and approval information. The schedule represents the date and time when the parameters of the machine configuration information should be changed. The schedule is not limited to fixed date and time but periodic date and time may be specified (for example, the same time on each day, a particular day and time of the week, and a particular day and time of the month or year). The parameters of the machine configuration information are information representing the specific contents of the machine configuration. The approval information of the machine configuration information is information representing the approval result or the progress statue of the approval procedure.

Next, the flow of the machine configuration information reception process will be described.

FIG. 7 is a flowchart illustrating the flow of an example of a machine configuration information reception process.

When a machine configuration change request is received from a user (ACT 21: YES), the processor 11 of the system control unit 10 creates machine configuration information corresponding to the contents of the machine configuration for which the change request has been received using the configuration management unit 61 (ACT 22). The configuration management unit 61 changes the approval information of the machine configuration information to an unapproved state (waiting for approval). That is, the configuration management unit 61 creates machine configuration information which is not approved. When the machine configuration information is created, the configuration management unit 61 requests the schedule management unit 63 to register the created machine configuration information in the machine configuration information list 18b (ACT 23). The schedule management unit 63 registers the unapproved machine configuration information in the machine configuration information list 18b in response to the request from the configuration management unit 61. The configuration management unit 61 may register directly the created machine configuration information in the machine configuration information list 18b.

The machine configuration unit 61 requests the approval management unit 64 to approve the created machine configuration information (ACT 24). The approval management unit 64 performs an approval process for the machine configuration information in response to the approval request from the configuration management unit 61. After the approval request is sent, the configuration management unit 61 receives a notification of the approval result from the approval management unit 64 on an as-needed basis. When the registration of the machine configuration information and the approval request are completed, the configuration management unit 61 notifies the user (the user terminal or the operation panel) having sent the machine configuration change request of the fact that the reception of the machine configuration information has been completed (ACT 25).

By the reception process, the machine configuration unit 60 is able to maintain the contents of changes to the machine configuration requested by the user and start the approval procedure for the machine configuration information.

Next, an approval process for the machine configuration information will be described.

The digital multi-function peripherals 1 requests an approval candidate to approve a machine configuration requested by the user. In the machine configuration unit 60, the configuration management unit 61 requests the approval management unit 64 to perform an approval process for the created machine configuration information in response to the request from the user. The approval management unit 64 extracts all necessary approval candidates for the machine configuration information for which an approval request from the configuration management unit 61 has been received with reference to the approval candidate list 18a. The approval management unit 64 notifies each approval candidate of the approval request for the machine configuration information.

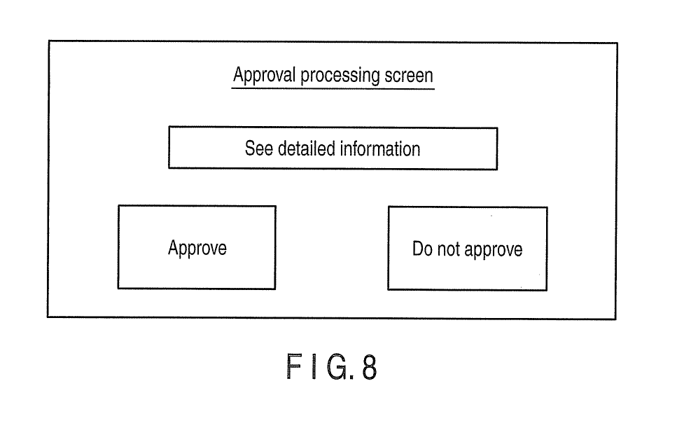

The approval candidate receives the approval request on the administrator terminal 4 or the like. For example, the administrator terminal 4 prompts the approval for the machine configuration information by displaying an approval processing screen when the approval candidate has logged in. FIG. 8 is a display example of the approval processing screen. In the display example shown in FIG. 8, the approval candidate selects an icon displayed as “Approve” when he/she approves the configuration contents, an icon displayed as “Do Not Approve” when he/she does not approve the configuration contents, and an icon displayed as “See Detailed Information” when he/she wants to see the configuration contents. The administrator terminal 4 notifies the approval management unit 64 of information representing the approval result by the approval candidate.

Moreover, the approval management unit 64 creates approval processing information based on the machine configuration information for which the approval request has been received from the configuration management unit 61 and the information on the approval candidate list 18a. The approval management unit 64 stores the created approval processing information in the approval processing information list 18c. The approval processing information is information representing the status of the approval process (approval procedure) for one machine configuration information. The approval management unit 64 updates the approval processing information whenever acquiring the approval result from each approval candidate.

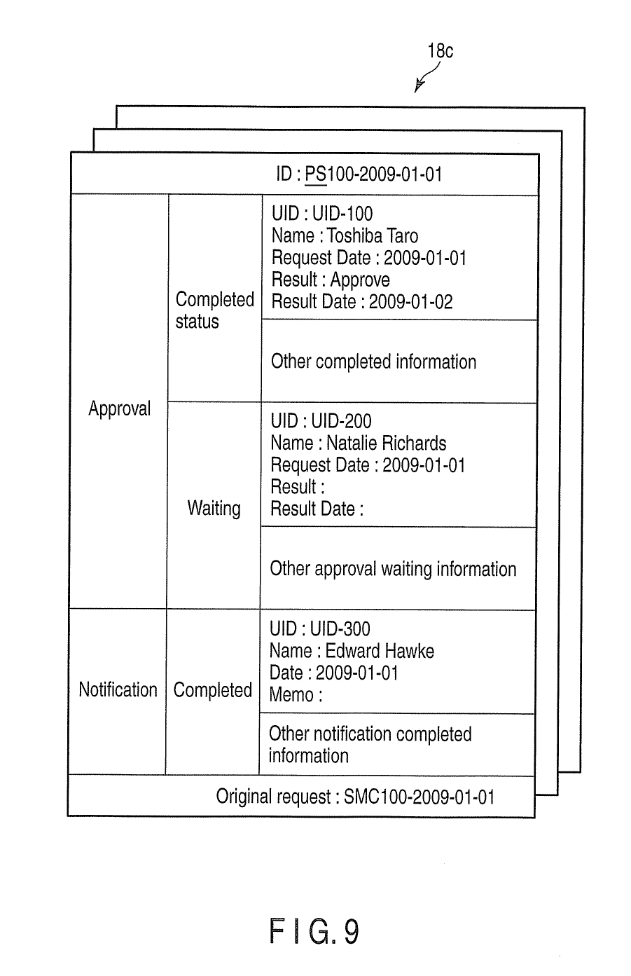

FIG. 9 is a diagram showing an example of the approval processing information list 18c.

The approval processing information list 18c is a list of approval processing information. In the example shown in FIG. 9, the approval processing information includes approval completed information, approval waiting information, and notification completed information. The approval completed information represents information (information for which the approval result has been obtained) for which approval has been completed. In the example shown in FIG. 9, UID “UID-100,” approval candidate name “Toshiba Taro,” approval request date “2009-01-01,” approval result “Approve,” approval result date “2009-01-02” are illustrated as information which has been approved. The approval waiting information represents information which is in the state of waiting for approval. In the example shown in FIG. 9, UID “UID-200,” approver name “Natalie Richards,” and approval request data “2009-01-01” are illustrated as information which waits for approval. The notification completed information represents information which has been notified. In the example shown in FIG. 9, UID “UID-300,” administrator name “Edward Hawke,” and notification date “2009-01-01” are illustrated as information which has been notified.

The approval management unit 64 changes the approval waiting information in the approval processing information of the approval processing information list 18c to the approval completed information whenever receiving the approval result from the approval candidate. The machine configuration information corresponding to the approval processing information in which there is no approval waiting information has been completed for the approval processing by all approval candidates. When the approval processing by all approval candidates has been completed for one machine configuration information, the approval management unit 64 notifies the configuration management unit 61 of the approval result. Upon receiving the approval result from the approval management unit 64, the configuration management unit 61 notifies the schedule management unit 63 of the information representing the approval result. The schedule management unit 63 reflects the approval result notified from the configuration management unit 61 in the approval information in the machine configuration information.

For example, when all approval candidates have approved the configuration contents, the schedule management unit 63 stores information representing the fact that the machine configuration information has been approved as the approval information of the machine configuration information. When not all of the approval candidates have approved the configuration contents, the schedule management unit 63 stores information representing the fact that the approval is not possible (application has not been allowed) as the approval information of the machine configuration information. The schedule management unit 63 may notify the user (the user terminal or the operation panel) having request the machine configuration of the approval result for the machine configuration information via the configuration management unit 61.

Next, the flow of the approval process in the approval management unit 64 will be described.

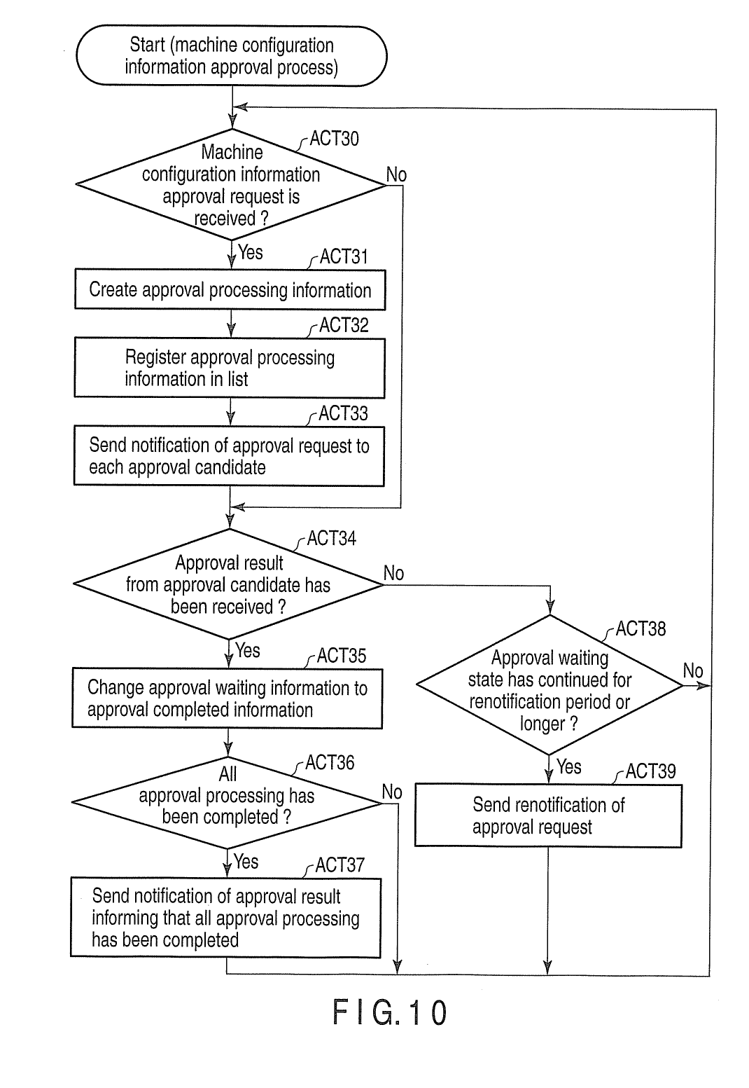

FIG. 10 is a flowchart illustrating the flow of the approval process by the approval management unit 64.

When a machine configuration information approval request is received from the configuration management unit 61 (ACT 30: YES), the approval management unit 64 creates approval processing information representing all approval candidates for the machine configuration information and the administrator to be notified using the configuration contents of the received machine configuration information and the approval candidates stored in the approval candidate list 18a (ACT 31). For example, the approval management unit 64 selects all approval candidates for each parameter included in the machine configuration information. The approval management unit 64 creates the approval processing information including the approval waiting information which represents information which waits for approval by each of the selected approval candidates. The approval management unit 64 registers the created approval processing information in the approval processing information list 18c (ACT 32).

When the approval processing information is registered in the approval processing information list 18c, the approval management unit 64 notifies each approval candidate for the approval processing information of the approval request (ACT 33). The approval management unit 64 determines a notification candidate of the approval candidate with reference to the information stored in the approval candidate list 18a. Moreover, the approval candidate may be notified by the configuration management unit 61. When the approval request is notified to each approval candidate, the approval processing information enters a state of waiting for the approval result from each approval candidate.

When the approval result is received from the approval candidate (ACT 34: YES), the approval management unit 64 specifies the approval processing information including the received approval result from the approval processing information list 18c. The approval management unit 64 changes the approval waiting information for which the approval result is obtained in the specified approval processing information to the approval completed information (ACT 35). When the approval waiting information is changed to the approval completed information, the approval management unit 64 determines whether or not there is any approval waiting information remaining in the approval processing information (ACT 36).

When there is no approval waiting information in the approval processing information, that is, when the approval processing information has been approved by all approval candidates (ACT 36: YES), the approval management unit 64 aggregates the approval results by all approval candidates and notifies the configuration management unit 61 of the approval result for the machine configuration information corresponding to the approval processing information (ACT 37). Upon receiving the approval result from the approval management unit 64, the configuration management unit 61 notifies the schedule management unit 63 of the approval result. The schedule management unit 63 registers the approval result notified via the configuration management unit 61 as approval information in the machine configuration information.

Moreover, the approval management unit 64 may renotify the approval candidate of the approval waiting information in each approval processing information of which the approval waiting state has continues for a predetermined period (renotification period) or longer. The approval management unit 64 monitors the duration (for example, the elapsed time after the approval request was notified) of the approval waiting state in each approval processing information. When there is information of which the approval waiting state has continued for the renotification period or longer (ACT 38: YES), the approval management unit 64 renotifies the approval candidate who has not approved for the renotification period or longer of the approval request (or confirmation of approval) (ACT 39).

The approval waiting information may have a valid period set thereto. When a valid period is set to the approval waiting information, the approval management unit 64 processes the approval result for the approval waiting information as not approvable if the approval waiting state has continues for the valid period or longer. The machine configuration information which has been processed as not approvable is classified as an invalid machine configuration. The machine configuration information classified as invalid may be removed from the machine configuration information list 18b.

According to the approval process, it is possible to select all approval candidates for the machine configuration information for which the approval request has been received in accordance with the approval candidate list 18a and notify each of the selected approval candidates of the approval request for the machine configuration information. Moreover, when the approval result is obtained from each approval candidate, the approval information of the machine configuration information is updated in accordance with the approval result from each approval candidate.

Next, schedule management for the machine configuration information will be described.

The schedule management unit 63 registers the machine configuration information in the configuration information list in response to the registration request from the configuration management unit 61. The schedule management unit 63 updates the approval information of the machine configuration information in accordance with the approval result by the approval management unit 64. Moreover, when the approval result by the approval management unit 64 shows that application of the machine configuration information is allowed (approved) by the approval candidate, the schedule management unit 63 manages the schedule of the machine configuration information as one configuration information (valid configuration information) that can be applied to the digital multi-function peripherals. The schedule management unit 63 retrieves machine configuration information of which the execution date and time have come from the machine configuration information list 18b. When valid machine configuration information of which the execution date and time have come has found, the schedule management unit 63 notifies the configuration management unit 61 of the retrieved machine configuration information as machine configuration information that should be executed (applied).

Next, the flow of schedule management of the machine configuration information in the schedule management unit will be described.

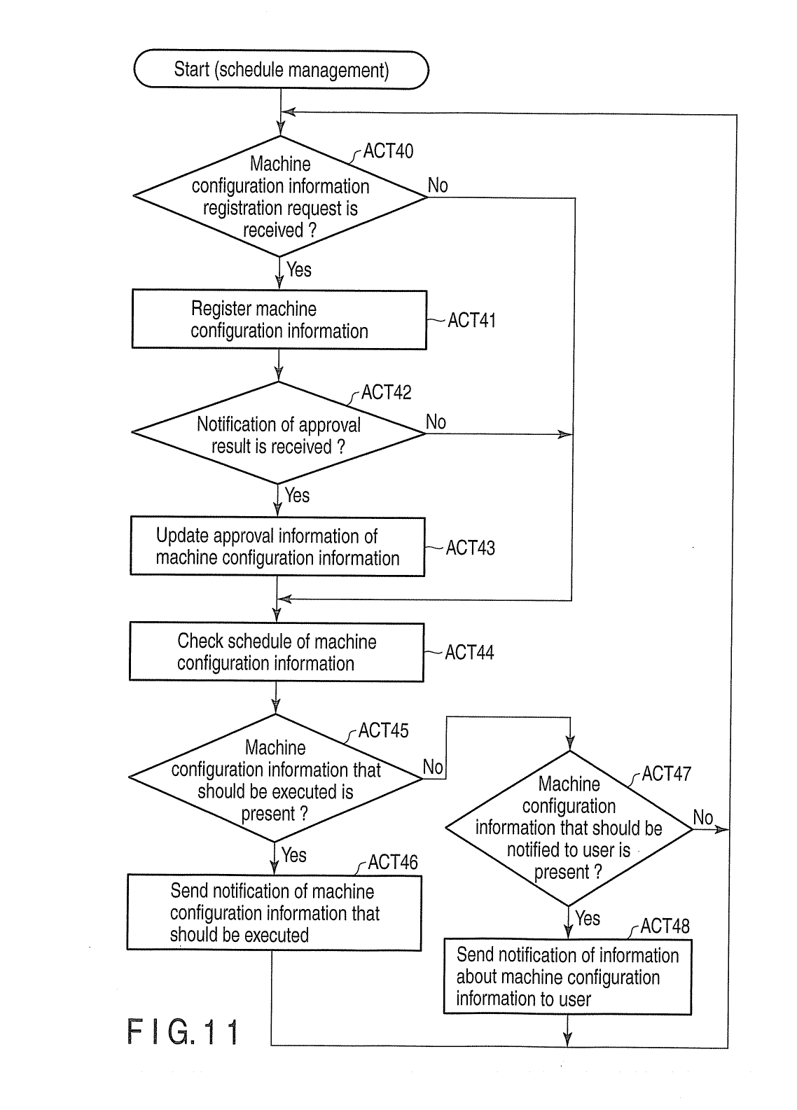

FIG. 11 is a flowchart illustrating an example of a schedule management process.

When a machine configuration information registration request is received from the configuration management unit 61 (ACT 40: YES), the schedule management unit 63 registers the machine configuration information in the machine configuration information list 18b (ACT 41). Moreover, when the approval result by the approval management unit 64 is received from the configuration management unit 61 (ACT 42: YES), the schedule management unit 63 updates the approval information of machine configuration information corresponding to the received approval result in accordance with the approval result (ACT 43).

The schedule management unit 63 checks the schedule of each machine configuration information in the machine configuration information list 18b (ACT 44). For example, the schedule management unit 63 checks whether or not the present date and time correspond to the execution date and time of the machine configuration information (valid machine configuration information which can be applied to the digital multi-function peripherals) allowed (approved) by the approval candidate. The schedule management unit 63 refers to the present time measured by the timer 19 and retrieves valid machine configuration information of which the execution date and time have come.

When valid machine configuration information of which the execution date and time have come is found (ACT 45: YES), the schedule management unit 63 notifies the configuration management unit 61 of the valid machine configuration information of which the execution date and time have come as machine configuration information that should be executed (applied) (ACT 46). Upon receiving the notification of the machine configuration information that should be executed (applied), the configuration management unit 61 instructs the configuration processing unit 62 to perform the machine configuration (change the machine configuration) with the machine configuration information. The configuration processing unit 62 stores the machine configuration information in the storage area 14a and executes the machine configuration with the machine configuration information.

The schedule management unit 63 may notify a user who has requested the machine configuration of the status of each machine configuration information registered in the machine configuration information list 18b. For example, the schedule management unit 63 may notify a user who has requested the machine configuration information (machine configuration information for which the approval processing has not been completed) for which the approval result has not been obtained for a predetermined period or longer among the machine configuration information registered in the machine configuration information list 18b.

Moreover, the schedule management unit 63 may notify the user of the approval result for the machine configuration information. Further, the schedule management unit 63 may notify the user of the machine configuration information (information for which approval was not obtained from all approval candidates) which was classified as invalid as the result of the approval processing.

It should be noted that in the machine configuration information reception process, in order to send a notification to the user, the configuration management unit 61 and the schedule management unit 63 register machine configuration information including information that represents a notification candidate of the requesting user in the machine configuration information list 18b.

When there is machine configuration information that should be notified to the user (ACT 47: YES), the schedule management unit 63 notifies the user of information on the machine configuration information (for example, the progress status of the approval process or the approval result) (ACT 48). For example, when notifying the user of machine configuration information for which the approval process has not been completed for a predetermined period or longer, the schedule management unit 63 notifies the user who has requested the machine configuration information of the fact that the approval process has not been completed.

According to the schedule management, it is possible to manage the schedule of machine configuration information (valid machine configuration information) for which approval was obtained from all approval candidates among the machine configuration information registered in the machine configuration information list 18b. Moreover, it is possible to change the machine configurations of the digital multi-function peripherals on the date and time designated in the machine configuration information which has been approved.

Next, a machine configuration information management process by the configuration management unit 61 will be described.

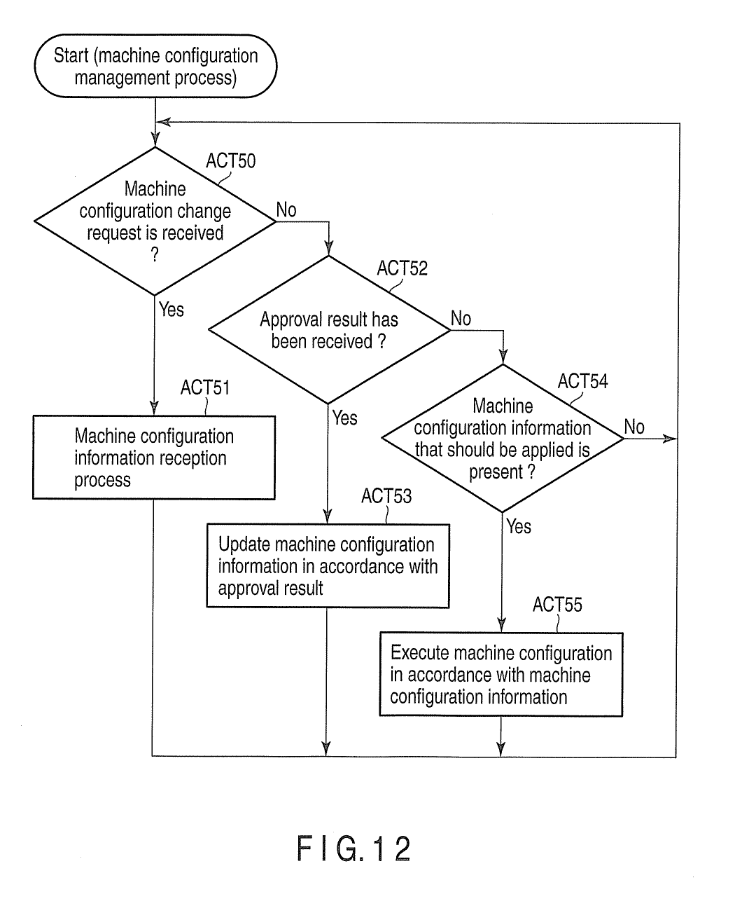

FIG. 12 is a flowchart illustrating the flow of a machine configuration information management process by the configuration management unit 61.

Upon receiving a machine configuration change request from the user (ACT 50: YES), the processor 11 of the system control unit 10 causes the configuration management unit 61 to perform a machine configuration information reception process in accordance with the contents of a machine configuration requested by the user (ACT 51). For example, the configuration management unit 61 performs the reception process by the processing of ACTS 21 to 25 described with reference to FIG. 7.

Moreover, upon receiving the approval result for the machine configuration information which has been requested for approval from the approval management unit 64 (ACT 52: YES), the configuration management unit 61 updates the approval information of the machine configuration information in accordance with the approval result by notifying the schedule management unit 63 of information representing the approval result (ACT 53). For example, if the machine configuration information has been approved by all approval candidates, the schedule management unit 63 stores information representing the fact that the machine configuration information has been approved as the approval information of the machine configuration information. If the machine configuration information has not been approved by all approval candidates, the schedule management unit 63 stores information representing the fact that the machine configuration information has not been approved as the approval information of the machine configuration information.

The schedule management unit 63 retrieves valid machine configuration information of which the execution date and time have come by the schedule management. When valid machine configuration information of which the execution date and time have come is found, the schedule management unit 63 notifies the configuration management unit 61 of the machine configuration information as machine configuration information that should be executed (applied).

Upon receiving the notification of the machine configuration information that should be executed (applied) from the schedule management unit 63 (ACT 54: YES), the configuration management unit 61 instructs the configuration processing unit 62 to perform the machine configuration (change the machine configuration) with the machine configuration information. The configuration processing unit 62 stores the machine configuration information in the storage area 14a of the non-volatile memory 14 and applies the machine configuration corresponding to the machine configuration information to the digital multi-function peripherals (ACT 55).

It should be noted that each unit of the machine configuration unit may be realized when the processor 21 of the server 2 executes a program. A part or an entirety of the configuration management unit 61, the configuration processing unit 62, the schedule management unit 63, and the approval management unit 64 may be realized by the server 2. For example, when the server 2 functions as the approval management unit 64, the digital multi-function peripherals 1 can reduce its load required for the approval process. When the server 2 functions as the schedule management unit 63, the digital multi-function peripherals 1 can reduce its load required for the machine configuration information schedule management. When the server 2 functions as the configuration management unit 61, the digital multi-function peripherals can reduce its load required for the machine configuration information reception process or the machine configuration information management process.

Further, when a plurality of digital multi-function peripherals is connected to the local area network, the server 2 may include a part or an entirety of the machine configuration units of the plurality of digital multi-function peripherals. The server 2 may be able to manage the control of the machine configurations of the plurality of digital multi-function peripherals in a unified manner.

In the present embodiment, machine configuration information representing the contents of a machine configuration for which a change request is received from a user is registered in a configuration information list, the schedule of the machine configuration information registered in the configuration information list is managed, and the machine configuration information is applied to the image forming apparatus in accordance with the schedule. According to the present embodiment, it is possible to manage the schedule of the machine configuration based on the machine configuration information.

Moreover, in the present embodiment, machine configuration information representing the contents of a machine configuration for which a change request is received from a user is registered in a configuration information list, an approval candidate for the machine configuration information registered in the configuration information list is specified by an approval candidate list, the schedule of the machine configuration information which has been approved by the specified approval candidate is managed, and the machine configuration information is applied to the image forming apparatus in accordance with the schedule. According to the present embodiment, it is possible to specify the correct approval candidate for the machine configuration information and reflect the approval result by an authorized approval candidate on the machine configuration information. As a result, the machine configurations of the digital multi-function peripherals can be managed by an authorized administrator (approval candidate), and the machine configurations can be set with enhanced easiness.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a configuration creating unit that creates machine configuration information in accordance with the contents of a machine configuration input by a user;
a storage that stores the machine configuration information created by the configuration creating unit;
a timer that measures the present date and time;
a schedule management unit that retrieves machine configuration information that is to be applied to the image forming apparatus based on the present date and time measured by the timer and the schedule of the machine configuration information stored in the storage; and
a configuration processing unit that applies machine configuration information retrieved by the schedule management unit as the machine configuration information to be applied to the image forming apparatus.

2. The apparatus according to claim 1, further comprising an approval management unit that manages an approval procedure of an administrator for the machine configuration information created by the configuration creating unit,
wherein the storage stores an approval result that the approval management unit acquired from the administrator and the machine configuration information in a correlated manner, and
the schedule management unit performs the retrieval from machine configuration information approved by the administrator among the machine configuration information stored in the storage.

3. The apparatus according to claim 1, further comprising a second storage that stores approval candidate information representing an approval candidate having the right to approve the machine configuration information to be stored in the storage,
wherein the approval management unit specifies an approval candidate for the machine configuration information created by the configuration creating unit using the approval candidate information stored in the second storage and requests an approval procedure to the specified approval candidate.

4. The apparatus according to claim 3,
wherein the second storage stores approval candidate information representing an approval candidate having the approval right for each configuration item.

5. The apparatus according to claim 3,
wherein the approval management unit specifies an approval candidate for the machine configuration information created by the configuration creating unit using the approval candidate information stored in the second storage and creates approval processing information representing the status of an approval procedure by the specified approval candidate, and
wherein the image forming apparatus further comprises a third storage that stores the approval processing information created by the approval management unit.

6. The apparatus according to claim 5,
wherein the approval management unit updates the approval processing information stored in the third storage whenever the approval result is acquired from the approval candidate.

7. The apparatus according to claim 6,
wherein the schedule management unit performs the retrieval from the machine configuration information stored in the storage when the approval processing information stored in the third storage shows that all approval candidates have approved the machine configuration information.

8. An image forming system comprising an image
forming apparatus and a server device connected to the image forming apparatus,
the server device includes
a configuration creating unit that creates machine configuration information in accordance with the contents of a machine configuration of the image forming apparatus;
a storage that stores the machine configuration information created by the configuration creating unit;
a timer that measures the present date and time; and
a schedule management unit that retrieves machine configuration information that is to be applied to the image forming apparatus based on the present date and time measured by the timer and the schedule of the machine configuration information stored in the storage, and
the image forming apparatus includes
a configuration processing unit that applies machine configuration information retrieved by the schedule management unit of the server device as the machine configuration information to be applied.

9. The system according to claim 8,
the server device further includes an approval management unit that manages an approval procedure of an administrator for the machine configuration information created by the configuration creating unit,
the storage stores an approval result that the approval management unit acquired from the administrator and the machine configuration information in a correlated manner, and
the schedule management unit performs the retrieval from machine configuration information approved by the administrator among the machine configuration information stored in the storage.

10. The system according to claim 8,
the server device further includes a second storage that stores approval candidate information representing an approval candidate having the right to approve the machine configuration information to be stored in the storage, and
wherein the approval management unit specifies an approval candidate for the machine configuration information created by the configuration creating unit using the approval candidate information stored in the second storage and requests an approval procedure to the specified approval candidate.

11. The system according to claim 10,
wherein the second storage stores approval candidate information representing an approval candidate having the approval right for each configuration item.

12. The system according to claim 10,
wherein the approval management unit specifies an approval candidate for the machine configuration information created by the configuration creating unit using the approval candidate information stored in the second storage and creates approval processing information representing the status of an approval procedure by the specified approval candidate, and
the server device further includes a third storage that stores the approval processing information created by the approval management unit.

13. The system according to claim 12,
wherein the approval management unit updates the approval processing information stored in the third storage whenever the approval result is acquired from the approval candidate.

14. The system according to claim 13,
wherein the schedule management unit performs the retrieval from the machine configuration information stored in the storage when the approval processing information stored in the third storage shows that all approval candidates have approved the machine configuration information.

15. A method of configuring an image forming apparatus, comprising:
creating machine configuration information in accordance with the contents of a machine configuration input by a user;
storing the created machine configuration information;
measuring the present date and time;
retrieving machine configuration information to be applied to the image forming apparatus based on the present date and time and the schedule of the stored machine configuration information; and
applying machine configuration information retrieved by the retrieving as the machine configuration information to be applied to the image forming apparatus.

16. The method according to claim 15, further comprising:
managing an approval procedure of an administrator for the created machine configuration information; and
storing an approval result acquired from the administrator and the machine configuration information in a correlated manner,
wherein the machine configuration information to be applied to the image forming apparatus is retrieved from machine configuration information approved by the administrator among the stored machine configuration information.

17. The method according to claim 15, further comprising:
storing approval candidate information representing an approval candidate having the approval right for each configuration item;
specifying an approval candidate for the created machine configuration information using the approval candidate information; and
requesting an approval procedure to the specified approval candidate.

18. The method according to claim 17, further comprising:
specifying an approval candidate for the created machine configuration information using the approval candidate information;
creating approval processing information representing the status of the approval procedure by the specified approval candidate; and
storing the created approval processing information.

19. The method according to claim 18, further comprising updating the approval processing information whenever the approval result is acquired from the approval candidate.

20. The method according to claim 19,
wherein the retrieving is performed from the machine configuration information corresponding to the approval processing information showing that all approval candidates have approved the machine configuration information.
